(19) United States
(12) Patent Application Publication
(10) Pub. No.: US 2025/0064041 A1
(43) Pub. Date: Feb. 27, 2025

(54) Bait Container

(71) Applicant: Q-LEAP TECHNOLOGY LIMITED, Leicester (GB)

(72) Inventors: Mohamed Nader El Sayed, Leicester (GB); Oliver Foster-Pollard, Leicester (GB)

(73) Assignee: Q-LEAP TECHNOLOGY LIMITED, Leicester (GB)

(21) Appl. No.: 18/866,547

(22) PCT Filed: May 10, 2023
(86) PCT No.: PCT/GB2023/051229

§ 371 Date: Nov. 17, 2024

(30) Foreign Application Priority Data
May 20, 2022 (GB) 2207429.8

(51) Int. Cl. A01K 97/02

(52) U.S. Cl. CPC A01K 97/02

(57) ABSTRACT

There is provided a bait container comprising a casing defining a cavity to contain bait in use, the casing having a closure moveable between a closed position and an open position in which the cavity is at least partially open to the environment. The bait container further comprises a retaining means for releasably securing the closure in the closed position, and the retaining means comprises a latch member provided on one of the closure or the casing. The latch member is configured to engage an engagement formation on the other of the closure or the casing, the latch member comprising a magnet. The retaining means comprises a magnetic arrangement movable to a first position where the latch magnet is biased into an engagement with the engagement formation, and to a second position where the latch magnet is biased out of engagement with the engagement formation.

### BACKGROUND OF THE INVENTION

A prior art bait container is shown in WO 2009/027713. The container comprises two nested hemicylinders 12, 14 to form a casing. The casings are rotatable relative to one another to open and close the container, thereby allowing the release of bait. The casings 12, 14 may be biased toward an open position. The casing has a latching arrangement configured to latch the hemicylinders to close the container. As shown in FIG. 4, the latch comprises a magnet 48 mounted to a solenoid 38 and configured to attract a magnetic portion 50 on one the casings. The magnetic 48 is movable away from the magnetic portion 50 allow release of the casing.

The inventor has found numerous problems with the prior art arrangement. The casing is held closed under the biasing force of the magnet. This must be strong enough to resist the opening bias between the casings. This, in turn requires that the solenoid has the mechanical strength to separate the magnets, thus increasing the size thereof and the power required to operate.

Other embodiments of the container in WO'713 use spring biased pin 66 to hold the casing in the closed position. The spring may suffer from fatigue or become deformed, or the pin 66 may become jammed in operation, particularly due to the shear force on the pin due to the rotating casings. Additionally, this arrangement may expose the mechanism to the external environment, accelerating corrosion and/or increasing the risk of contamination.

It is an aim of the present invention to overcome or ameliorate one or more of the above problems.

### STATEMENT OF INVENTION

According to a first aspect, there is provided: a bait container comprising: a casing defining a cavity to contain bait in use, the casing having a closure moveable between a closed position and an open position in which the cavity is at least partially open to the environment; a retaining means for releasably securing the closure in the closed position, the retaining means comprises a latch member provided on one of the closure or the casing and configured to engage an engagement formation on the other of the closure or the casing, the latch member comprising a magnet; where the retaining means comprises a magnetic arrangement movable to first position where the latch magnet is biased into an engagement with the engagement formation and a second position where the latch magnet is biased out of engagement with the engagement formation.

The magnetic arrangement may comprise a first magnet and a second magnet, the first and second positioned in opposing relative polarities.

The first and second magnet may be provided on a moveable carriage. The carriage comprises a rotatable carousel/disc/arm.

The carriage may be movable in a direction perpendicular to movement of the latch member between the engaged and disengaged position.

One of the latch member and the engagement formation may comprise a protrusion configured to be received within a recess on the other of the latch member and the engagement formation.

The engagement formation may comprise a ramped or stepped interface.

The latch member may comprise a pivotable arm. The latch member may be provided on the closure or the casing. The latch member may be moveable relative to the magnetic arrangement.

The closure may be biased into the open position. The closure may be biased via a torsion spring.

The container may comprise an at least partially open cage. The cage may be at least partially received within the casing. The cage may be moveable (e.g. rotatable) relative to the container to allow access to the interior of the cavity.

The container may be cylindrical. The casing and/or closure may be hemicylindrical. The cage may be hemicylindrical.

The retaining means may be provided at an axial end of the container. The closure and casing may be concentrically arranged. The closure may be received on an inner or outer surface of the casing. The closure may pivot/rotate relative to the casing.

The cage may comprise a retaining means to secure the cage in a closed position. The retaining means may comprise a magnet.

The cage may comprise a handle or flange. The retaining means may be provided on the handle or flange.

The latch member may physically spaced or isolated from the magnetic arrangement in the first position. The magnetic arrangement (e.g. moveable carriage) and/or electronic components of the container may be contained within a watertight housing.

The container may comprise a sensor to detect the position of the closure. The sensor may comprise a magnetic (e.g. hall effect or REED) sensor. The closure or the casing may comprise a magnet, the sensor configured to detect the magnet.

The container may comprise a further retaining means. The further retaining mean may comprise a plurality of pins. One of the pins may be provided on the casing and the other of the pins on the closure. A tension member is provided between the pin to bias the together in use. The tension member may be elastic.

The container may comprise a clock or timer, and a controller is configured to release the closure after a predetermined period of time.

The container may comprise a wired or wireless communication interface (e.g. USB, Bluetooth (RTM) or Wifi).

The container may comprise a sensor configured to detect the presence of a remote device, and the controller is configured to selectively control power to one or more electrical component of the container in response to detection of the remote device. The electrical component may comprise the communication interface. The sensor may comprise a magnetic (e.g. hall effect or REED) sensor. The remote device may comprise a magnet.

The controller may be configured to selectively control operation of the retaining means in response to input of a unique or authentication code. The code may comprise a self-validating code.

The controller may be configured to move the magnetic arrangement to the first position in response to input of the code. The controller may prevent operation of magnetic arrangement if a code is not supplied. The controller may be configured to invalidate the code in response to operation of the retaining means (e.g. movement of the magnetic arrangement). The controller may comprise a list/log of invalidated codes. The code may be generated/augmented using an identifier (e.g. serial code) of the remote device and/or container.

According to a further aspect of the invention, there is provided: a bait container comprising: a casing defining a cavity to contain bait in use, the casing having a closure moveable between a closed position and an open position in which the cavity is at least partially open to the environment; a retaining means for releasably securing the closure in the closed position, the retaining means comprises a latch member provided on one of the closure or the casing the closure and configured to engage an engagement formation on the other of the closure or the casing, the latch member comprising a magnet; where the magnet is provided on a moveable carriage, and the carriage is movable in a direction perpendicular to movement of the latch member between the engaged and disengaged position.

The magnet may be movable to first position where the latch magnet is biased into an engagement with the engagement formation. The magnet may be movable to a second position where the latch magnet is biased out of engagement with the engagement formation.

According to a further aspect of the invention, there is provided: a bait container comprising: a casing defining a cavity to contain bait in use, the casing having a closure moveable between a closed position and an open position in which the cavity is at least partially open to the environment; a retaining means for releasably securing the closure in the closed position, and where a controller is configured to selectively control operation of the retaining means in response to input of a unique or authentication code.

Any optional or preferable features described in relation to any one aspect of the invention may be applied to any further aspect, wherever practicable.

### DETAILED DESCRIPTION

Practicable embodiments of the disclosure are described below in further detail, by way of example only, with reference to the accompanying drawings, of which:

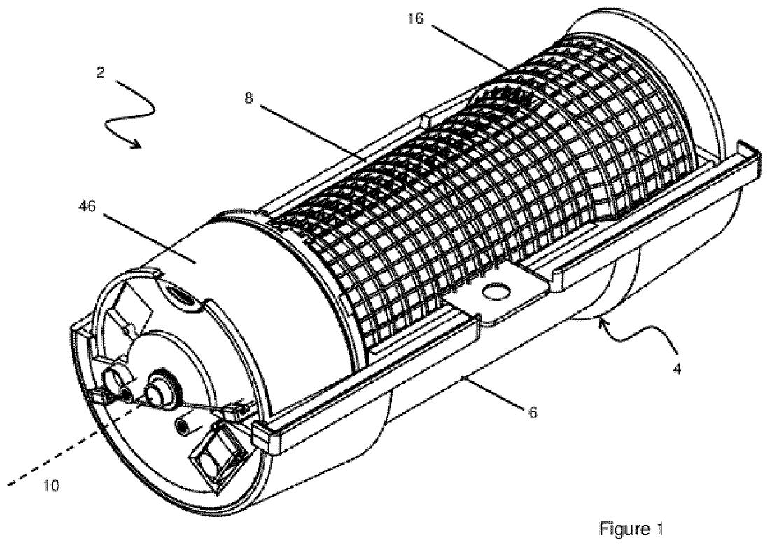

FIG. 1 shows a perspective view of a bait container in an open configuration;

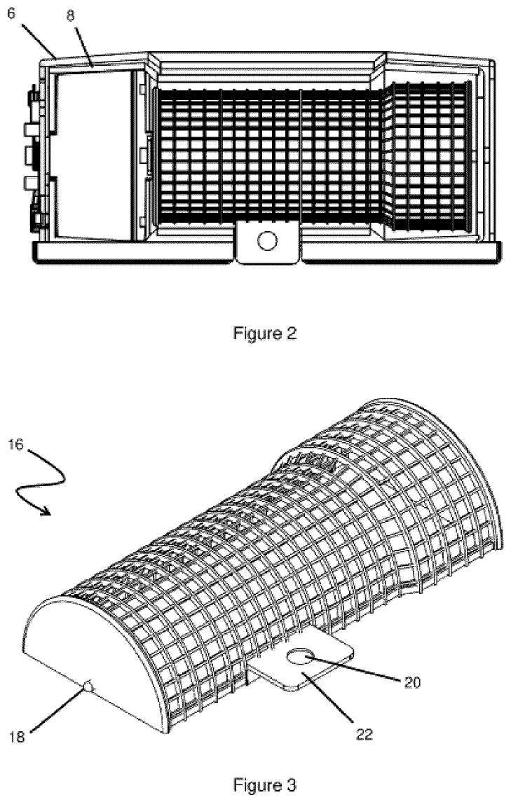

FIG. 2 shows a top-down view of the bait container;

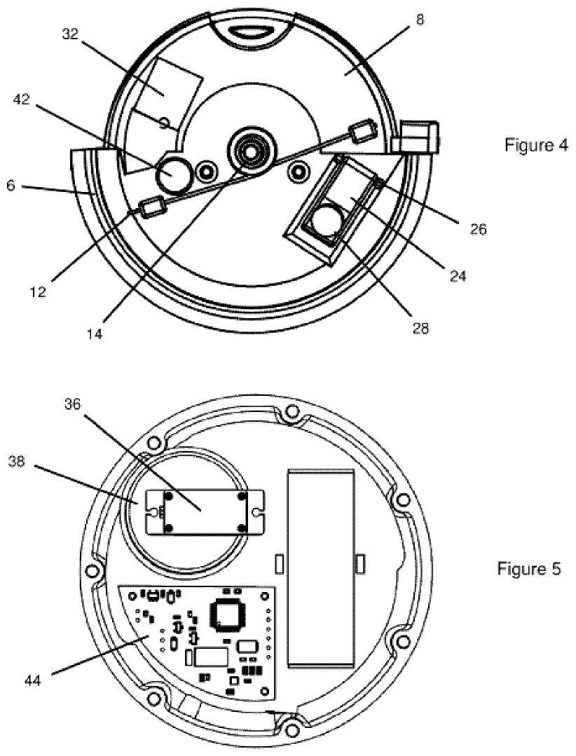

FIG. 3 shows a perspective view of a cage for the container;

FIG. 4 shows a sectional view of a latching mechanism of the container;

FIG. 5 shows a sectional view of an electronics compartment of the container;

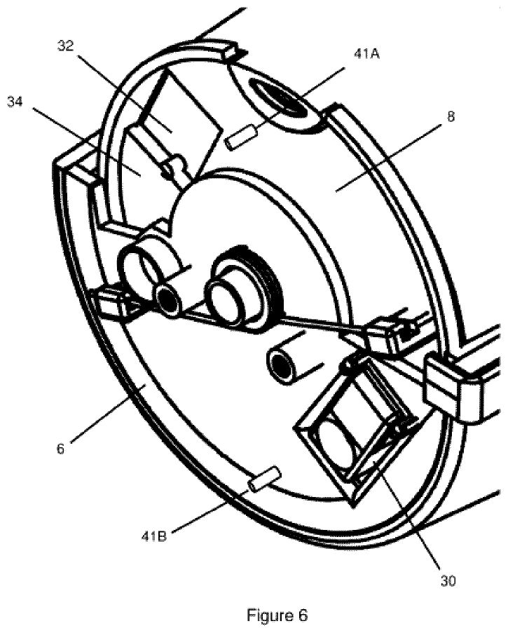

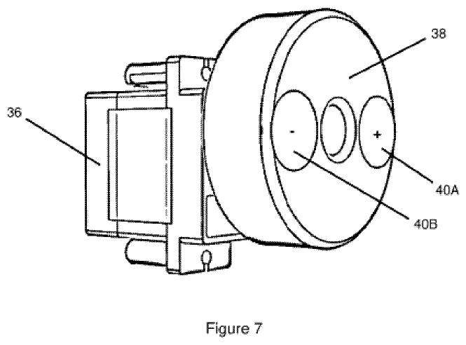

FIG. 6 shows a close-up perspective view of the latching mechanism;

FIG. 7 shows a perspective view of carousel of the latching mechanism;

FIG. SA shows a sectional view of the latching mechanism in operation;

FIG. 88 shows a perspective view of the latching mechanism in operation;

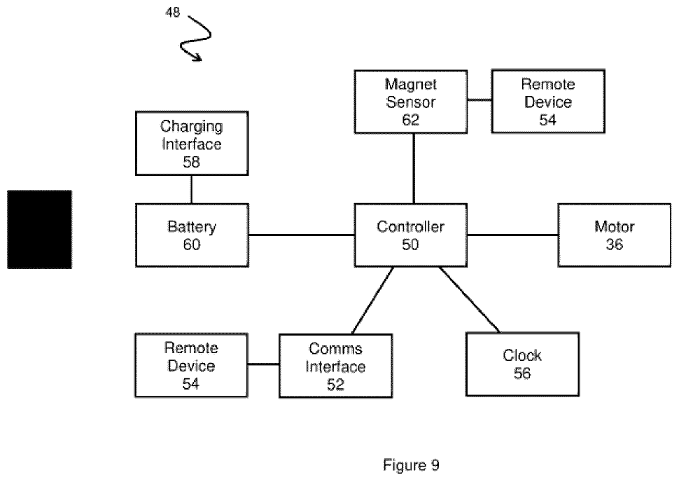

FIG. 9 shows a schematic view of a control system of the container;

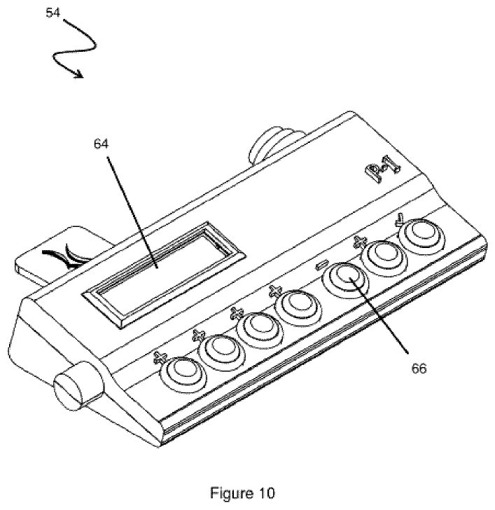

FIG. 10 shows a perspective view of a remote device for the container.

A bait container 2 is shown in FIGS. 1 and 2. The bait container 2 is configured to dispense bait, food, chum, or any other suitable products to attract fish, crustaceans, or other waterborne species.

The container 2 comprises a casing 4. The casing 4 is generally cylindrical. The casing comprises a first casing 6. A second casing 8 is received within the first casing 6 (most easily seen in FIG. 2). The first and second casings 6,8 are hemicylindrical. The first casing 6 is rotatable relative to the second casing 8 to effectively open and close the container. The first casing 6 thus provides a closure. The first casing 6 is rotatable about the axial length 10 of the container 2. The casings 6,8 are thus concentrically arranged/nested.

The casing 4 is biased toward an open position (i.e. that shown in FIG. 1). As shown in FIG. 4, the bias is provided by a torsion spring 12. One end of the spring 12 is fixed to the inner casing 8 and the second end thereof is fixed to the outer casing 6. The spring 12 is mounted to a hub or spindle 14. It can be appreciated that the biasing force or relative movement between the casings 6,8 may be provided by any suitable means. For example, in some embodiments, the casing 6,8 may be driven apart by a motor or the like.

A cage arrangement 16 is provided on the device 2. The cage 16 provides a cavity to receive bait/chum. The cage 16 comprise an open structure (e.g. grating, grille, or mesh) to allow bait or water to at least partially enter the surrounding environment. The cage 16 is received within the inner casing 8. The bait cavity is thus defined between the cage 16 and the inner casing 8. The cage 16 is thus effectively open and closed by the outer casing 6. The cage 16 is hemicylindrical.

The cage 16 is movably mounted to the casing 4, thereby allowing access to an interior thereof. This allows filling the cage 16. The cage 16 is rotatably mounted to the casing 4. The cage 16 is mounted via a spindle/pin 18 provided at one or both end of the cage 16. The casing 4 comprises a corresponding recess to receive the pin 18.

The cage 16 comprises a retention mechanism to retain the cage 16 in the closed position (i.e. as shown in FIG. 1). Thus as shown in FIG. 1, the casing 4 is open by virtue of the position of the inner casing 8, which exposes the cage 16, whilst the cage is in a closed condition to define a bait enclosure.

The retention mechanism comprises a magnet 20. The magnet 20 is configured to engage a magnet/magnetic material provided on the casing 4. The casing 4 may comprises a metallic strip to receive the magnet 20. The magnet 20 is provided on an outwardly extending flange or tab 22. The flange 22 may provide a handle.

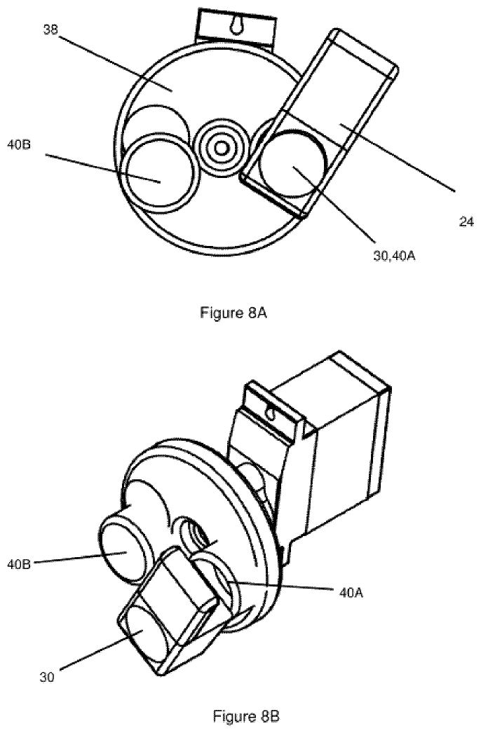

With reference to FIGS. 4-8, the container 2 comprises a latch mechanism configured to control opening of the casing 4. The latch mechanism comprises a latch member 24. The latch member 24 is pivotally mounted to the outer casing 6 via a hinge 26. The latch 24 thus comprise a pivotable arm. The latch 24 comprises a magnet 28. The magnet 28 is provided at an opposing end of the latch 24 to the hinge 26. The magnet 28 is therefore pivotable toward/away from the inner casing 8 in use.

The latch 24 comprises an engagement formation 30 (best seen in FIG. 6). The engagement formation 30 is configured to be received or abut a corresponding formation 32 on the inner casing 6. The respective formation 30,32 comprises complementary shapes. Thus, when the formations 30,32 are engaged, relative rotation between the casings 6,8 is prevented. The latch formation 30 comprises a rectangular protrusion. The formation 32 on the inner casing 8 comprises a rectangular recess or step accordingly. It can be appreciated the formations 30,32 may comprise any suitable shape or arrangement. For example, either or both of the inner and outer casing may comprise protruding surfaces configured to be received by a recess or abutment on the other of the inner and outer casing.

The formation 32 on the inner casing 8 comprise a ramped leading edge 34. This increases the effective depth of the recessed formation 32 (i.e. to provide a step). The formation 30 on the latch 24 may comprise taper/ramped/rounded leading edge to ensure the latch 24 can smoothly ride the ramp 34.

Referring the FIG. 5, the container 2 comprises a motor 36. The motor 36 may comprise any suitable form. The motor 36 may comprises a servomotor or stepper motor. The motor 36 is powered by any suitable power supply. Typically, the power supply comprises a battery. The battery may be rechargeable and/or removable.

The motor 36 is configured to drive a carousel 38. The carousel and motor are shown in insolation in FIG. 7. The carousel 38 provides a rotatable plate, disc or puck. The carousel 38 comprises a first magnet 40A and a second magnet 40B. The magnets 40A,40B are arranged with reversed polarities (shown schematically as “+” and “−”). The polarities are reversed with respective to the flat face of the axis carousel or the axis of rotation thereof. It can be appreciated that the exact form of the carousel is not pertinent to the invention at hand. For example, the carousel may comprise a rotatable arm, bar or flange configured to provide rotation of the magnets 40A,40B.

As shown in figures SA and 8B, the carousel 38 is arranged adjacent the inner casing formation 32. The planar face of the carousel is generally planar to the end wall of the container. The magnets 40A,40B are therefore adjacent the formation 32 (when in a suitable rotational position, for example as shown by the corresponding orientations of FIGS. 4 and 5). As such, when the latch member 24 is engaged with the formation 32, the magnet 28 on the latch 24 is either attracted to the magnet 40A,40B on the carousel 38 or repelled thereby. As such, the latch 24 is either drawn into engagement with the inner casing formation 32, securing the latch, or repelled out of engagement with the inner casing formation 32, releasing the latch. Selective rotation of the carousel 38 may therefore secure or release latch 24.

For example, if the magnet 28 on the latch 24 comprises a negative polarity and the positive polarity magnet 40A is in position adjacent the inner casing formation 32, then the engagement formation 30 on the latch 24 is held in position in the formation 32 due to the attraction of the magnets 30,40A. If the carousel 38 is rotated such that the positive polarity magnet 40B is in position adjacent the inner casing formation 32, then the engagement formation 30 on the latch 24 is disengaged from the formation 32 due to the repulsion of the magnets 30,408 accordingly. Once the formations 30,32 are disengaged, the outer casing 6 is free to rotate to the open position under the bias of the spring 12.

The magnets 40A, 40B are provided in diametrically opposed positions (i.e. separated by 180 degrees). The carousel may therefore do a full rotation to arrive at a starting position. In other embodiments, the magnets 40A,B may be spaced by less than 180 degrees. In some embodiments, multiple pairs of magnets or magnets of the same polarity may be provided. For example, the two pairs of magnets may be spaced by 90 degrees. Each of the magnets 40A,B may be same size, shape and/or strength (i.e. magnetic density). The magnets 40A,B are provided at the same radial spacing relative to the rotational axis.

In can be appreciated that in general terms, the latch 24 is released by reversing the polarity of the magnet on the inner casing 8. In some embodiments, the magnets 40A,B may be provided on a linearly movable carriage or slider. The magnets are movable about a plane perpendicular to the movement of the latch (i.e. the magnet 40A,B rotates about the plane of the page in FIG. 4, and latch moves in/out of the plane).

In some embodiments, single a magnet may be provided, and the magnet is rotated to reverse the polarity thereof in the vicinity of the formation 30/32. In some embodiments, a single magnet may provide the repulsive effective, and a magnetic material may provide the attractive effect with the magnet 28 of the engagement formation 30.

In some embodiments, the latch member 24 may be biased into the release/disengaged state via a basing member (e.g. a spring). The carousel may therefore comprise an attractive magnet which is configured to be rotated away to provide release thereof. The converse arrangement could also be used, where the latch member 24 is biased to an engaged state by a biasing member (e.g. a spring) and a single repulsive magnet is provided on the carousel to disengage the latch by virtue of a repelled magnet 28 on engagement formation 30 (i.e. to overcome the biasing member.

Referring to FIG. 6, a further retaining means may be provided to retain the closure in the closed position. The retaining mean comprises pins 41A,41B. One of the pins is mounted to the inner casing 8 and the other to the outer casing 6. The outer casing 6 may comprise a groove or aperture (not shown), with the pin passing therethrough to allow rotation of the outer casing 6. The groove/aperture is arcuate. In use, a tension member (e.g. elastic cord or the like) is provided to the pins to bias the pins together. The pins 41A,41B are positioned proximal/adjacent one another when the outer casing 6 is in the closed position. The bias between the pins 41A,41B forces the latch 24 into further engagement with the engagement formation 32 (i.e. the side walls thereof) to increase the latching force. The tension member may then be release before use to allow opening of the container. The pins 41A,41B may comprise a hook, flange or aperture to secure the tension member.

The container 2 comprises a sensor to detect opening/closing thereof (i.e. relative movement of outer casing 6). The sensor may comprise any suitable arrangement. In the present embodiment, the sensor comprises a magnetic sensor. A magnet 42 is provided on the outer casing. A magnetic sensor (e.g. a hall sensor) is provided on the inner casing 8. The magnetic sensor may be provided on a PCB 44 or the like provided within the inner casing 8. The magnet 42 is therefore detected whenever the magnet 42 passes over or resides above the PCB 44. In other embodiments, a REED switch, or other proximity sensor (e.g. pressure or contact sensor) may be used.

The electronic components (e.g. motor 36, PCB 44) of the container 2 are provided within an electronics compartment 46 (see FIG. 1). The electronics compartment comprises a sealed and/or waterproof container. The magnetic carousel 38 is therefore isolated from external environment and the latch member 24. The magnets 40A,B of the carousel and the magnet 30 for the latch 22 are therefore physically separated or spaced (e.g. by the walls of the electronics compartment 46). The electronics compartment 46 is provided adjacent an end of the container 2.

The container 2 comprises a control system to control operation of the device. The system 48 is shown schematically in FIG. 9. The system 48 comprises a controller 50. The controller 50 may comprise any suitable hardware/software (e.g. a processor, RAM, ROM). The controller 50 may comprise memory (e.g. flash memory). The system 48 may comprises a communications interface 52. The interface 52 may comprises a wired or wireless interface. The interface may comprise one or more of: USB; Wifi; Bluetooth (RTM); GSM; 3G; 4G; 5G; NFC etc.

The interface allows communication with a remote computing device 54. The remote device 54 may comprise any suitable hardware/software. The remote device 54 may comprise one or more of: mobile (cellular) phone; laptop; desktop computer; tablet computer; server; microcomputer; or bespoke computing device.

The system 48 comprise a clock 56. The clock may provide an absolute or relative time (e.g. to provide a timer). The latch 24 may be configured to be released after a certain period of time. The container 2 may therefore open after a certain period of time accordingly. The time period may be programmed into the system 48.

In some embodiments, the closure may open in accordance with one or more of: temperature; pressure; temperature; or other environmental parameter. The container may comprise a light sensor, pressure sensor, and temperature sensor accordingly. For example, the container may be configured to open at a predetermined depth. The appropriate pressure/temperature/light level are programmed into the container accordingly. In some embodiments, the container 2 may receive commands from the remote device 54 (e.g. over the wireless interface). In some embodiments, the closure may open in response to proximity to one or more predetermined component or applied field. For the example, the container may comprise a magnetic sensor to detect an external magnet or applied field.

A charging interface 58 may be provided to charge the battery 60. The charging interface 58 may be provided by USB or the like.

A magnetic sensor 62 detects opening/closing of the container 2 and/or the position of the outer casing 6, as previously described. In some embodiments, the magnetic sensor 62 is used to detect the presence of the remote device 54. The magnetic sensor 62 may comprise a hall effect or REED sensor. The remote device 54 comprises a magnet accordingly. The controller 50 may be configured to activate and/or increase power to one or more further components of the system 48 in response to detection of the magnet. This system 48 thus saves power when not operatively connected to a remote device. In the present embodiment, the communication interface 52 is configured to be activated only when a magnet on the remote device is detected.

An example of the remote device 54 is shown in FIG. 10. The remote device 54 comprise a bespoke device configured to operatively communicate with the container 2. The remote device 54 comprises a suitable communications interface accordingly. The remote device 54 comprises a display 64. The display 54 may comprise any suitable form, for example, an LCD display. The remote device 54 comprises one or more manual inputs, for example, a button/switch 66. The remote device 54 may therefore provide an effective interface/input for the container 2.

Communication between the remote device 54 may be unidirectional (i.e. the remote device 54 merely sends commands/inputs to the container 2). In other embodiments, communication is bidirectional. For example, the remote device 54 may receive sensor or other stored data from the container 2. The container 2 may transmit battery/power level data to the remote device 54. The remote device 54 may be configured to interrogate/read and/or alter data stored on the container 2 and vice versa.

The remote device 54 is shaped to engage to the container 2. For example, a portion of the remote device 54 may be correspondingly shape to casing 4 of the container 4. The rear side (i.e. a side opposing the display 64/inputs 66) may comprise a curved shape.

The container 2 may only be configured to operate in the event the container 2 receives a unique code. For example, the latch mechanism may not operate without the code, and thus the user is unable to close the device. This prevents unauthorised use of the device. The code may comprise any suitable binary, hexadecimal, alphanumeric etc. code or string.

The unique code may be purchased or otherwise obtained by the user. The user may obtain codes via a user portal or profile (e.g. via the internet). Typically, the user may purchase a plurality of codes. The code(s) is then transmitted or input to the remote device 54. For example, the codes may be emailed or sent via SMS to a user mobile device. The codes may then be input/transmitted to the remote device 54.

The code(s) may then be transmitted or input to the container 2. The code(s) are stored in memory on the remote device 54 and/or container 2. The code is validated by the remote device 54 and/or container 2 to ensure authenticity. Validation may be performed using any suitable algorithm. For example, the code may comprise a self-validating code (i.e. one or more integer comprises a check/validation integer). In some embodiments, the code may be verified against a list of known codes (e.g. a database thereof).

The code may be generated/augmented using an identifier for the remote device 54 and/or container 2. For example, the code may be generated/augmented using a serial number thereof. The code may therefore only be valid for a device having the identifier/serial.

Once the latching mechanism has been released and/or a latching/unlatching cycle has been completed, the code is invalidated and/or discarded. The code may therefore not be used again, and further codes must be obtained. The container 2 and/or remote device 54 may contain a record of invalidated codes. The record of invalided codes may be transmitted to a remote server (e.g. to ensure they are not used again). Similarly, when the user obtains one or more codes, the codes are recorded to ensure the same codes are not distributed at a later time.

When a code is input into the remote device 54 and/or container 2, the code is checked against the record of invalidated (i.e. used) codes. If the code matches an invalidated code, the code is rejected and the container does not operate. The user may be notified or prompted to input a valid code. If the code does not match an invalidated code, then the device operates as normal.

### OPERATION OF THE INVENTION

The user obtains one or more codes to activate the system. The codes are input on the remote device 54 and then stored on the container memory. At this stage, the carousel may move to a position to attract the latch 24. A timer may be programmed into the container 2 to determine the release time. The cage 16 is rotated to an open position using the handle 22. Bait/chum is inserted into the cavity defined by the cage 16/inner casing 8. The cage 16 is rotated back to the closed position and secured using the magnetic latch 20.

The outer casing 6 is moved to the closed position against the bias of the spring 12, and the latch 24 engages the engagement formation 32. The magnetic carousel is provided in a position to attract the latch 24 into engagement with the formation 32. The container 2 may then be deposited into water as required.

Once the timer reaches the predetermined time period, the carousel 38 is rotated, and the latch 24 repelled out of engagement with the engagement formation 32. The outer casing 6 rotates to the open position under the bias of the spring 12 and the cage 16 is exposed to the water. Water may therefore enter the cage 16 and mix with the bait. Some bait may egress the cage 16. The user then retrieves the container 2 and the process is repeated. The user inputs a new code, or a further code in the database is validated, and carousel moves back to the attracted position.

The latching arrangement provides mechanical resistance to the biasing force of the spring, thereby mitigating the need to provide a strong magnetic attachment and/or actuator. The electronic control and actuators are sealed and separated from the external environment and the latch, thus providing a more reliable system and/or reducing contamination. The code system ensures that only authorised user may use the device.

1. A bait container comprising:
a casing defining a cavity to contain bait in use, the casing having a closure moveable between a closed position and an open position in which the cavity is at least partially open to the environment; and
a retaining means for releasably securing the closure in the closed position, the retaining means comprises a latch member provided on one of the closure or the casing and configured to engage an engagement formation on the other of the closure or the casing, the latch member comprising a magnet,
wherein the retaining means comprises a magnetic arrangement movable to first position where the latch magnet is biased into an engagement with the engagement formation and a second position where the latch magnet is biased out of engagement with the engagement formation.

2. The bait container of claim 1, wherein the magnetic arrangement comprises a first magnet and a second magnet, the first and second positioned in opposing relative polarities.

3. The bait container of claim 2, wherein the first and second magnet are provided on a moveable carriage.

4. The bait container of claim 3, wherein the carriage comprises a rotatable carousel.

5. The bait container of claim 4, wherein the carriage is movable in a direction perpendicular to movement of the latch member between the engaged and disengaged position.

6. The bait container of claim 5, wherein one of the latch member and the engagement formation comprise a protrusion configured to be received within a recess on the other of the latch member and the engagement formation.

7. The bait container of claim 6, wherein the engagement formation comprises a ramped or stepped interface.

8. The bait container of claim 7, wherein the latch member comprises a pivotable arm.

9. The bait container of claim 8, wherein the closure is biased into the open position.

10. The bait container of claim 9, further comprising an at least partially open cage at least partially received within the casing.

11. The bait container of claim 10, wherein the cage is moveable relative to the container to allow access to the interior of the cavity.

12. The bait container of claim 11, wherein the cage comprises a retaining means to secure the cage in a closed position.

13. The bait container of claim 12, wherein the retaining means comprises a magnet.

14. The bait container of claim 13, wherein the retaining means is provided on a handle or flange.

15. The bait container of claim 14, wherein the latch member is physically spaced or isolated from the magnetic arrangement in the first position.

16. The bait container of claim 15 wherein the magnetic arrangement and/or electronic components of the container are contained within a watertight housing.

17. The bait container of claim 16, further comprising a sensor to detect the position of the closure.

18. The bait container of claim 17, further comprising a clock or timer, and a controller is configured to release the closure after a predetermined period of time.

19. The bait container of claim 18, further comprising a wired or wireless communication interface.

20. The bait container of claim 19, further comprising a sensor configured to detect the presence of a remote device, and the controller is configured to selectively control power to one or more electrical component of the container in response to detection of the remote device.

21. The bait container of claim 20, wherein the electrical component comprises the communication interface.

22. The bait container of claim 21, wherein the controller is configured to selectively control operation of the retaining means in response to input of a unique or authentication code.

23. The bait container of claim 22, wherein the controller is configured to move the magnetic arrangement to the first position in response to input of the code.

24. The bait container of claim 23, wherein the controller is configured to invalidate the code in response to operation of the retaining means.

25. A bait container comprising:
a casing defining a cavity to contain bait in use, the casing having a closure moveable between a closed position and an open position in which the cavity is at least partially open to the environment; and
a retaining means for releasably securing the closure in the closed position, and where a controller is configured to selectively control operation of the retaining means in response to input of a unique or authentication code.
